(19) United States
(12) Patent Application Publication
(10) Pub. No.: US 2023/0237423 A1
(43) Pub. Date: Jul. 27, 2023

(54) CONSUMABLE MANAGEMENT APPARATUS, NON-TRANSITORY COMPUTER READABLE MEDIUM STORING COMPUTER PROGRAM, AND CONSUMABLE MANAGEMENT METHOD

(71) Applicant: FUJIFILM Business Innovation Corp., Tokyo (JP)

(72) Inventor: Yoshiyuki YODA, Kanagawa (JP)

(73) Assignee: FUJIFILM Business Innovation Corp., Tokyo (JP)

(21) Appl. No.: 17/902,890

(22) Filed: Sep. 4, 2022

(30) Foreign Application Priority Data
Jan. 21, 2022 (JP) 2022-008182

(51) Int. Cl. G06Q 10/08

(52) U.S. Cl. CPC G06Q 10/0833; G06Q 10/087

(57) ABSTRACT

A consumable management apparatus includes a processor configured to periodically acquire remaining amount information, which is related to a remaining amount to be used until replacement of a consumable, and a replacement history of the consumable, from an apparatus provided with the consumable, acquire information about a delivery period, which is from shipment of the consumable to arrival of the consumable at an installation place of the apparatus, and a delivery time period corresponding to the replacement history, predict a replacement time period of the consumable provided in the apparatus by using the remaining amount information, and determine a time point that is before the delivery period, which is obtained in accordance with the delivery time period, from the predicted replacement time period, as a time point for shipping the consumable to the installation place.

### CROSS-REFERENCE TO RELATED APPLICATIONS

This application is based on and claims priority under 35 USC 119 from Japanese Patent Application No. 2022-008182 filed Jan. 21, 2022.

### BACKGROUND

### (i) Technical Field

The present invention relates to a consumable management apparatus, a non-transitory computer readable medium storing a computer program, and a consumable management method.

### (ii) Related Art

JP2002-318678A discloses a consumable providing system that sends an e-mail for ordering consumables in consideration of the shortest number of days until the remaining amount of the consumables in an apparatus disappears from a record of the remaining amount of the consumables in the apparatus from Near Empty to Near End, and the number of days required for delivery.

JP2017-119561A discloses a remote management system that calculates the number of days for delivery from location information of a delivery base of a consumable and an installation place of an apparatus, arranges the consumable, and determines a threshold value of the remaining amount of the consumable.

### SUMMARY

In a case where a delivery period from shipment of a consumable to delivery fluctuates depending on a time period, the efficiency of using the consumable may decrease because a new consumable does not arrive in time for the replacement timing of the consumable and because the new consumable arrives too early, on the contrary, and is replaced before the consumable is completely consumed.

Aspects of non-limiting embodiments of the present disclosure relate to a consumable management apparatus, a non-transitory computer readable medium storing a computer program, and a consumable management method that is capable of reducing the occurrence of downtime due to missed arrival of a consumable and reducing the decrease in efficiency of using a consumable due to the early arrival of the consumable, as compared with a case where the fluctuation of a delivery period is not taken into consideration.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a consumable management apparatus including a processor configured to periodically acquire remaining amount information, which is related to a remaining amount to be used until replacement of a consumable, and a replacement history of the consumable, from an apparatus provided with the consumable, acquire information about a delivery period, which is from shipment of the consumable to arrival of the consumable at an installation place of the apparatus, and a delivery time period corresponding to the replacement history, predict a replacement time period of the consumable provided in the apparatus by using the remaining amount information, and determine a time point that is before the delivery period, which is obtained in accordance with the delivery time period, from the predicted replacement time period, as a time point for shipping the consumable to the installation place.

### BRIEF DESCRIPTION OF THE DRAWINGS

Exemplary embodiment(s) of the present invention will be described in detail based on the following figures, wherein:

FIG. 1 is a diagram showing a schematic configuration of a consumable management system including a consumable management server according to an exemplary embodiment;

FIG. 2 is a block diagram showing a hardware configuration of the consumable management server;

FIG. 3 is a block diagram showing an example of a functional configuration of the consumable management server;

FIG. 4 is a diagram showing an example of information stored in a consumable status database;

FIG. 5 is a diagram showing an example of information stored in the consumable status database;

FIG. 6 is a diagram showing an example of information stored in a delivery record database;

FIG. 7 is a flowchart showing a flow of consumable management processing by the consumable management server;

FIG. 8 is a flowchart showing a flow of the consumable management processing by the consumable management server;

FIG. 9 is a diagram showing a schematic configuration of the consumable management system including the consumable management server according to the exemplary embodiment; and

FIG. 10 is a flowchart showing a flow of the consumable management processing by the consumable management server.

### DETAILED DESCRIPTION

Hereinafter, an example of the exemplary embodiment of the present invention will be described with reference to the drawings. The identical reference numerals are given to the identical or equivalent components and portions in each drawing. Further, the dimensional ratios in the drawings are exaggerated for convenience of explanation and may differ from the actual ratios.

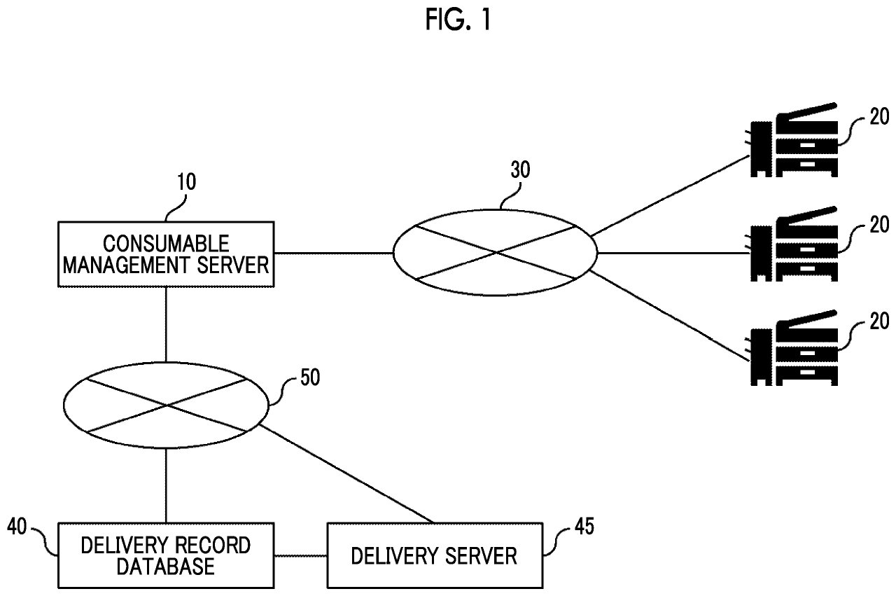

FIG. 1 is a diagram showing a schematic configuration of a consumable management system including a consumable management server according to the present exemplary embodiment.

A consumable management server 10 is an example of a consumable management apparatus of the exemplary embodiment of the present invention, and is a server that checks the remaining amount of a consumable in an apparatus 20 in which the consumable is used and instructs a delivery company to deliver the consumable in a case where the remaining amount is low. The apparatus 20 is, for example, a multifunction apparatus including at least a printing function, and for example, in a case where the apparatus 20 is a multifunction apparatus, the consumable used in the apparatus 20 is, an item, such as toner, whose amount decreases with each use or an item, such as a drum, that needs to be replaced after the predetermined number of times of use. The consumable management server 10 registers the apparatus 20, for which a delivery service contract has been made, as a consumable management target in advance. The consumable management server 10 and the apparatus 20 are connected by a network 30 such as an internet line or a dedicated line. Although three apparatuses 20 are shown in FIG. 1, the number of apparatuses 20 is not limited to such an example.

The consumable management server 10 predicts a timing that is a replacement time period of the consumable of the apparatus 20 and instructs a delivery server 45 to deliver the consumable to a place where the apparatus 20 is placed in order to be able to replace the consumable with a new consumable at the timing of the replacement time period of the consumable. In a case where the consumable management server 10 instructs the delivery server 45 to deliver the consumable, the consumable management server 10 designates a place where the apparatus 20 is placed and a shipping date according to a delivery time period. In a case where the consumable management server 10 can refer to a delivery record database 40 described later, the consumable management server 10 designates the place where the apparatus 20 is placed and the shipping date according to the delivery time period by referring to information recorded in the delivery record database 40. In a case where the consumable management server 10 cannot refer to the delivery record database 40 described later, the consumable management server 10 designates the place where the apparatus 20 is placed and the shipping date according to the delivery time period by referring to the past replacement record of the consumable in the apparatus 20.

For example, an assumption is made that an exhaustion date when the remaining amount of the consumable in the apparatus 20 is exhausted is predicted to be the date of X, and the number of days required for delivery of the consumable to the area at that time period, that is, the number of days from shipment to arrival is 2 days. The consumable management server 10 instructs the delivery server 45 to ship the consumable two days before the date of X, that is, on the date of (X−2). Further, for example, in a case where the exhaustion date of the consumable of the apparatus 20 is predicted to be the date of Y, and the number of days required for delivery of the consumable to the area at that time period is 3 days, the consumable management server 10 instructs the delivery server 45 to ship the consumable on the date of (Y−3). The consumable management server 10 may instruct the delivery server 45 to ship the consumable such that the consumable does not arrive on the predicted exhaustion date of the consumable of the apparatus 20, but arrives with a margin such as the day before and the day before yesterday. Further, in a case where there are holidays, special days, consecutive holidays, or the like between the shipment and arrival of the consumable, the consumable management server 10 may instruct the delivery server 45 to deliver in consideration of the days.

The delivery record database 40 is a database managed by a distribution company. The delivery record database 40 stores information about commodity delivered by the distribution company, and in detail, stores information such as a slip number, a shipping date, and an arrival date. Specific examples of the information stored in the delivery record database 40 will be described later.

The delivery server 45 is a server managed by the distribution company. The delivery server 45 executes processing related to delivery of the commodity. In a case where the delivery server 45 receives a delivery instruction of the consumable from the consumable management server 10, a delivery person carries the consumable out of a warehouse based on the delivery instruction and ships the consumable to a designated shipping destination on the designated shipping date. The consumable management server 10, the delivery record database 40, and the delivery server 45 are connected by a network 50 such as an Internet line.

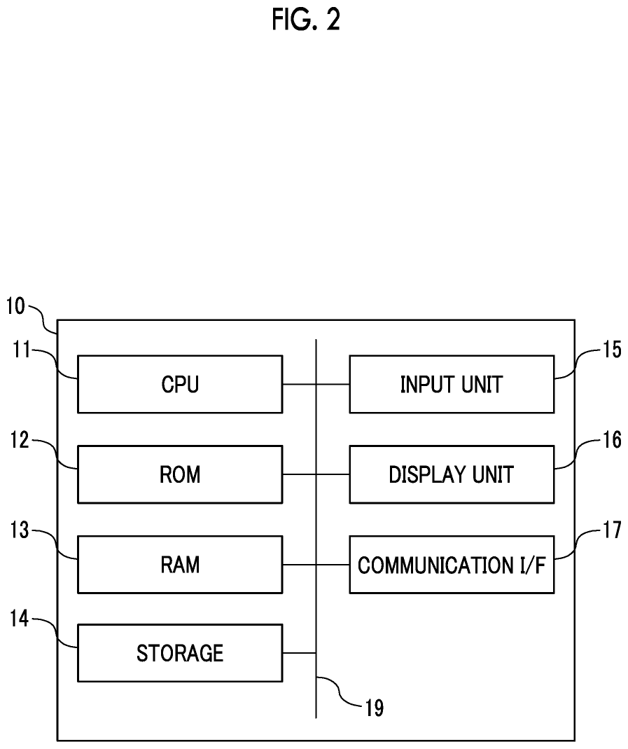

FIG. 2 is a block diagram showing a hardware configuration of the consumable management server 10.

As shown in FIG. 2, the consumable management server 10 includes a central processing unit (CPU) 11, a read only memory (ROM) 12, a random access memory (RAM) 13, a storage 14, an input unit 15, a display unit 16, and a communication interface (I/F) 17. The respective configurations are connected to each other via a bus 19 so as to be communicable with each other.

The CPU 11 is a central arithmetic processing unit that executes various programs and controls each unit. That is, the CPU 11 reads the program from the ROM 12 or the storage 14, and executes the program using the RAM 13 as a work area. The CPU 11 performs control of each of the above configurations and performs various calculation processing according to the program recorded in the ROM 12 or the storage 14. In the present exemplary embodiment, the ROM 12 or the storage 14 stores a computer program that manages the consumable used in the apparatus 20.

The ROM 12 stores various programs and various data. The RAM 13 temporarily stores a program or data as a work area. The storage 14 is configured with a storage device such as a hard disk drive (HDD), a solid state drive (SSD), or a flash memory, and stores various programs including an operating system and various data.

The input unit 15 includes a pointing device such as a mouse and a keyboard, and is used for performing various inputs.

The display unit 16 is, for example, a liquid crystal display and displays various types of information. The display unit 16 may adopt a touch panel method and function as the input unit 15.

The communication interface 17 is an interface for communicating with other apparatuses such as the apparatus 20, the delivery record database 40, and the delivery server 45, and for example, standards such as Ethernet (registered trademark), FDDI, and Wi-Fi (registered trademark) are used.

In a case where the above computer program is executed, the consumable management server 10 implements various functions by using the above hardware resources. The functional configuration that is implemented by the consumable management server 10 will be described.

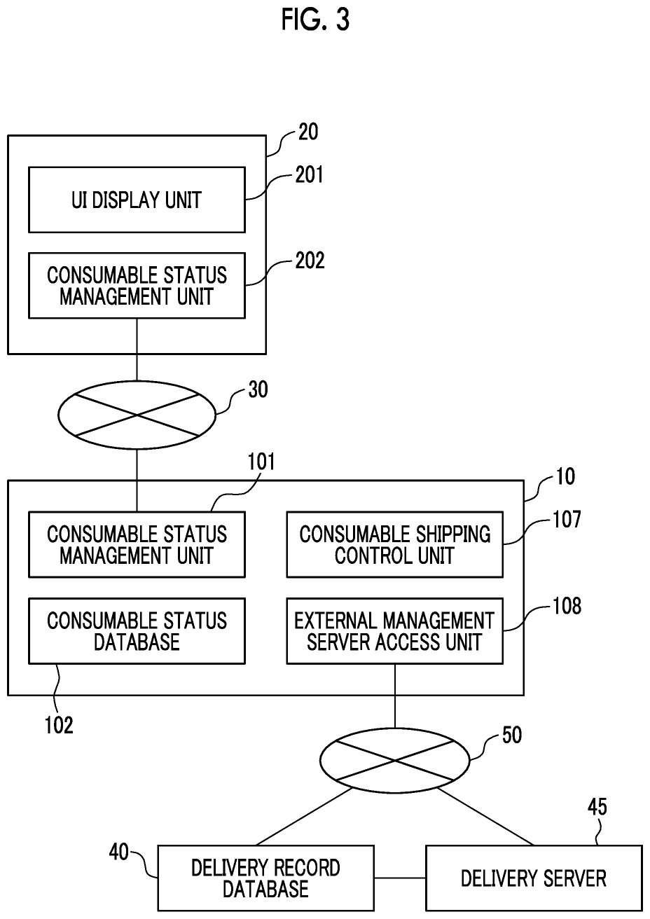

FIG. 3 is a block diagram showing an example of a functional configuration of the consumable management server 10. FIG. 3 also shows an example of a functional configuration example of the apparatus 20 in a block diagram.

As shown in FIG. 3, the consumable management server 10 includes a consumable status management unit 101, a consumable status database 102, a consumable shipping control unit 107, and an external management server access unit 108 as functional configurations. Each functional configuration is implemented by the CPU 11 reading the computer program, which is stored in the ROM 12 or the storage 14, and executing the computer program. Further, as shown in FIG. 3, the apparatus 20 includes a user interface (UI) display unit 201 and a consumable status management unit 202 as functional configurations.

The consumable status management unit 101 communicates with the consumable status management unit 202 of the apparatus 20 and manages a status of the consumable of the apparatus 20. The consumable status management unit 101 acquires the status of the consumable of the apparatus 20, for example, the remaining amount, information about the number of times of remaining use until the replacement, and a replacement history of the consumable. The consumable status management unit 101 stores the information acquired from the apparatus 20 in the consumable status database 102. From the apparatus 20, the status of the consumable may be transmitted to the consumable management server 10 according to an operation of the user interface displayed by the UI display unit 201, and the status of the consumable may be transmitted to the consumable management server 10 at a predetermined cycle.

Further, the consumable status management unit 101 predicts the replacement time period of the consumable of the apparatus 20 by using the information acquired from the apparatus 20. For example, in a case where the remaining amount of the consumable is 30% at the time point on December 1st, and the remaining amount of the consumable is 20% at the time point on December 8th, the consumable status management unit 101 predicts that December 22nd is the replacement time period of the consumable. Of course, the consumable status management unit 101 may predict the replacement time period of the consumable by using the information about the remaining amount for 3 days or more.

The consumable status database 102 is a database that records information related to the status of the consumable of the apparatus 20. The information related to the status of the consumable of the apparatus 20 includes information related to the remaining amount of the consumable acquired from the apparatus 20 and information related to the shipment of the consumable.

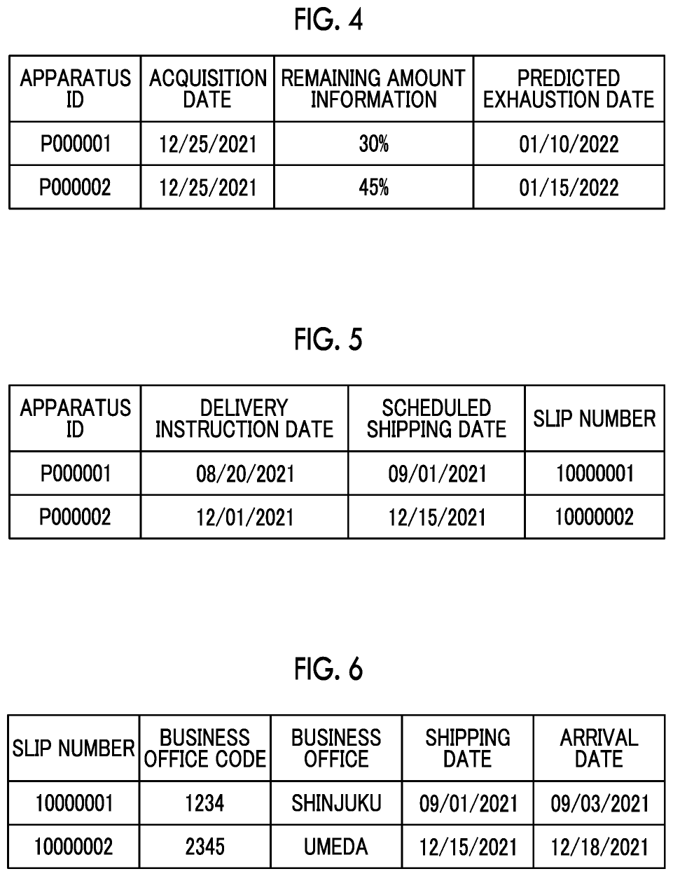

FIG. 4 is a diagram showing an example of the information stored in the consumable status database 102. FIG. 4 shows an example of the information related to the remaining amount of consumable stored in the consumable status database 102. The information for identifying the apparatus 20 is stored in an apparatus ID column. The date when the status of the consumable is acquired from the apparatus 20 is stored in an acquisition date column. The information about the remaining amount of the consumable from the apparatus 20 is stored in a remaining amount information column. In a case where the consumable is to be replaced after a predetermined number of times of use, such as a drum, an unused status may be set as 100% and stored in the remaining amount information column, and a status in which the number of times of use reaches the number of times of replacement may be set as 0% and stored in the remaining amount information column. A predicted exhaustion date column is the exhaustion date of the consumable of the apparatus that is predicted by the consumable status management unit 101. In a case where there are a plurality of consumables in the apparatus 20, a line is created for each consumable.

FIG. 5 is a diagram showing an example of the information stored in the consumable status database 102. FIG. 5 shows an example of the information related to the remaining amount of consumable stored in the consumable status database 102. The information for identifying the apparatus 20 is stored in an apparatus ID column. The date, on which the instruction is made for delivery of the consumable to the place where the apparatus 20 is installed, is stored in a delivery instruction date column. The date, on which the shipment of the consumable is scheduled to the place where the apparatus 20 is installed, is stored in a scheduled shipping date column. The information about the slip number of the slip attached when the consumable is shipped is stored in a slip number column. The information about the slip number may be acquired from the delivery record database 40 or may be manually input.

The consumable shipping control unit 107 performs control related to the shipment of the consumable of the apparatus 20. More specifically, the consumable shipping control unit 107 performs control for instructing the delivery server 45 to ship the consumable at an appropriate timing with reference to the information recorded in the consumable status database 102 and the information recorded in the delivery record database 40.

For example, an assumption is made that the consumable status management unit 101 predicts the exhaustion date of the consumable of the apparatus 20 as the date of X, and as a result of referring to the delivery record database 40, the number of days required for the delivery of the consumable at that time period to the area where the apparatus 20 is installed is two days. The consumable shipping control unit 107 instructs the delivery server 45 to ship the consumable on the date of (X−2). The consumable shipping control unit 107 may instruct the delivery server 45 to ship the consumable such that the consumable does not arrive on the predicted exhaustion date of the consumable of the apparatus 20, but arrives with a margin such as the day before and the day before yesterday. Further, in a case where there are holidays, special days, consecutive holidays, or the like between the shipment and arrival of the consumable, the consumable shipping control unit 107 may instruct the delivery server 45 to deliver in consideration of the days.

FIG. 6 is a diagram showing an example of information stored in the delivery record database 40. The information is stored in the delivery record database 40 by the processing of the delivery server 45. Information about the slip number is stored in the slip number column. The information stored in the slip number column corresponds to the slip number column of a database shown in FIG. 5. Information about a business office code that identifies a business office of a distribution company in charge of delivering a package of the relevant slip number is stored in a business office code column. Information about a business office of a distribution company in charge of delivering a package of the relevant slip number is stored in a business office column. A shipping date of a package of the relevant slip number is stored in a shipping date column. An arrival date of a package of the relevant slip number is stored in an arrival date column.

The external management server access unit 108 accesses an apparatus such as a server that is managed externally. In the present exemplary embodiment, the external management server access unit 108 accesses the delivery record database 40 and the delivery server 45.

Next, the operation of the consumable management server 10 will be described.

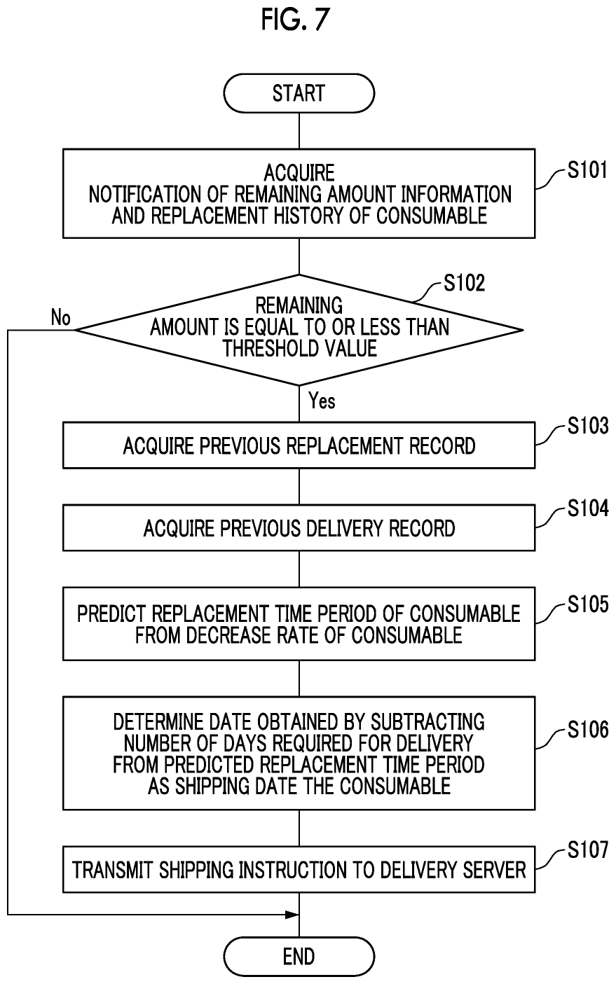

FIG. 7 is a flowchart showing a flow of the consumable management processing by the consumable management server 10. The consumable management processing is performed by the CPU 11 reading a computer program from the ROM 12 or the storage 14, loading the computer program into the RAM 13, and executing the computer program.

In step S101, the CPU 11 acquires notification of information about the remaining amount of consumable and information about the replacement history of consumable from each of the apparatuses 20. The CPU 11 stores the acquired information in the consumable status database 102.

In a case where the notification of the information about the remaining amount of the consumable and the information about the replacement history of the consumable is acquired, the CPU 11 subsequently determines whether the remaining amount of the consumable in the apparatus 20 is equal to or less than a predetermined threshold value in step S102. The predetermined threshold value is any value and may be, for example, 50% or 100%. In a case where the remaining amount of the consumable in the apparatus 20 is not equal to or less than the predetermined threshold value (step S102: No), the CPU 11 ends a series of processing. On the other hand, in a case where the remaining amount of the consumable in the apparatus 20 is equal to or less than the predetermined threshold value (step S102: Yes), the CPU 11 subsequently acquires the previous replacement record of the apparatus 20 from the consumable status database 102 in step S103.

In a case where there is no replacement record of the consumable in the apparatus 20, the CPU 11 searches the replacement record of the consumable for the apparatus 20, as a target, installed in the same area and searches the replacement record of the apparatus in which the replacement is recently performed. In a case where there is no apparatus 20 in which the replacement of the consumable is performed in the same area, the CPU 11 immediately delivers the consumable as exception processing and sets the replacement as the first record to be referred to in the next determination processing. Here, the same area in the present exemplary embodiment is a range in which consideration can be made that there is substantially no difference in the number of delivery days from the delivery base, which is predetermined. Besides the physical distance, areas where the number of days required for delivery is expected to be substantially constant are grouped in advance in consideration of a development situation of a transportation network such as crossing borders that require customs clearance and detouring mountain ranges. Therefore, even the same municipality may not constantly be in the same area, and different municipalities may be in the same area.

In a case where the previous replacement record of the apparatus 20 is acquired, the CPU 11 subsequently acquires the previous delivery record of the consumable of the apparatus 20 from the delivery record database 40 in step S104. Since the result of the past delivery record does not change for each reference, the CPU 11 may cache the delivery record once the CPU 11 refers to the delivery record database 40. Further, the CPU 11 may cache the delivery record after referring to the delivery record database 40 when the delivery happens, instead of referring to the delivery record database 40 in the above flow.

In a case where the previous delivery record of the consumable of the apparatus 20 is acquired from the delivery record database 40, the CPU 11 subsequently predicts the replacement time period of the consumable from a decrease rate of the consumable of the apparatus 20 in step S105. For example, in a case where the remaining amount of the consumable is 30% at the time point on December 1st, and the remaining amount of the consumable is 20% at the time point on December 8th, the CPU 11 predicts that December 22nd is the replacement time period of the consumable. The CPU 11 may predict that the date when the consumable is exhausted as the replacement time period in a case where the decrease rate of the consumable during a period when the consumable is consumed most in apparatus 20 is maintained in the future.

In a case where the replacement time period of the consumable is predicted, the CPU 11 subsequently determines the date obtained by subtracting the number of days required for the delivery from the predicted replacement time period as the shipping date of the consumable in step S106. The CPU 11 determines the shipping date of the consumable such that a new consumable arrives on the date when the replacement time period of the consumable has come, or a new consumable arrives the day before the date when the replacement time period of the consumable has come.

In a case where the shipping date of the consumable is determined, the CPU 11 subsequently transmits a shipping instruction of the consumable to the delivery server 45 in step S107. The shipping instruction of the consumable includes information about the consumable to be shipped, a shipping date of the consumable, and a shipping address of the consumable.

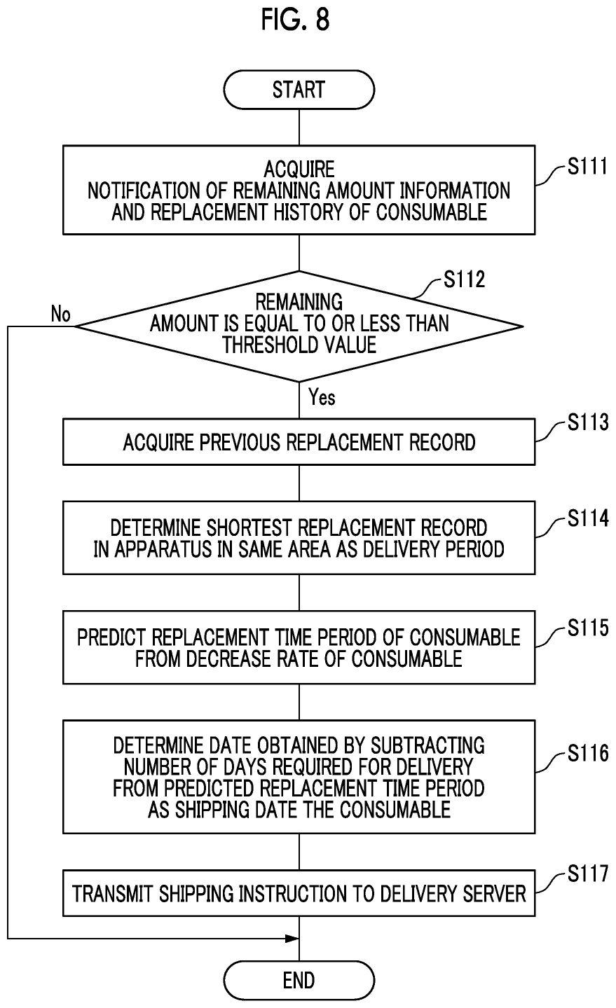

FIG. 8 is a flowchart showing a flow of the consumable management processing by the consumable management server 10. The consumable management processing is performed by the CPU 11 reading a computer program from the ROM 12 or the storage 14, loading the computer program into the RAM 13, and executing the computer program. FIG. 8 is a flowchart in a case where the consumable management server 10 cannot refer to the delivery record database 40.

Since steps S111 to S113 are identical to steps S101 to S103 in FIG. 7, detailed description thereof will be omitted. In a case where the previous replacement record of the apparatus 20 is acquired, the CPU 11 subsequently searches for a record, which has the shortest number of days from the shipping date of the consumable to the replacement date, from the replacement record of the consumable of the apparatus 20 in the same area as the apparatus 20, and sets the number of days as the number of days required for delivery, in step S114. Considering that some users replaces the consumable as soon as the consumable for replacement is sent, even before the replacement time period of the consumable, the date when the replacement happens at the earliest is considered to be an arrival date of the consumable.

Since steps S115 to S117 are identical to steps S105 to S107 in FIG. 7, detailed description thereof will be omitted.

In this way, even in a case where the delivery record database 40 cannot be referenced, the consumable management server 10 can make the instruction of the shipment of the consumable in consideration of the delivery period of the consumable according to the time period by referring to the past replacement history of the consumable.

An assumption is made that the remaining amount of the consumable at present is 30% and the remaining amount one week ago is 40%. In a case where the increase or decrease in the number of people is not taken into consideration, the replacement time period of the consumable is after 3 weeks. However, in a case where the remaining amount two weeks ago is 45%, a consumption rate of the consumable is not constant, and the prediction of the replacement time period of the consumable only by the transition of the remaining amount is difficult.

Therefore, in a case where the consumable management server 10 predicts the replacement time period of the consumable of the apparatus 20, the consumable management server 10 may acquire information about the number of people who can use the apparatus 20 and may use the fluctuation in the number of people who can use the apparatus 20 in addition to the remaining amount information of the consumable. The consumable management server 10 accurately predicts the replacement time period of the consumable by using the fluctuation of the number of people who can use the apparatus 20 as compared with a case of predicting the replacement time period of the consumable only by the transition of the remaining amount.

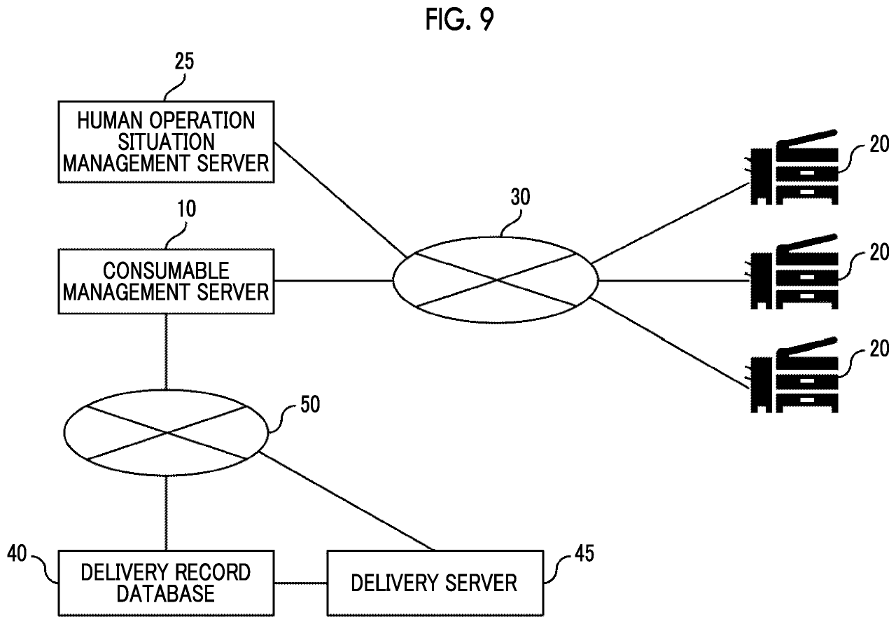

FIG. 9 is a diagram showing a schematic configuration of a consumable management system including the consumable management server according to the present exemplary embodiment. The consumable management system shown in FIG. 9 is a consumable management system shown in FIG. 1 to which a human operation situation management server 25 is added.

The human operation situation management server 25 is a server that manages a human operation situation in a place where the apparatus 20 is installed, for example, a company, a school, or the like. In a case where the apparatus 20 is installed in a company, the human operation situation management server 25 manages the number of employees working in the company as the human operation situation. In a case where the apparatus 20 is installed in a school, the human operation situation management server 25 manages the number of students attending the school as the human operation situation. The human operation situation management server 25 manages information about the number of people on a daily basis as a human operation situation. Further, the human operation situation management server 25 may manage the human operation situation expected in the future, for example, the information about the number of employees working or the number of students attending school in the future.

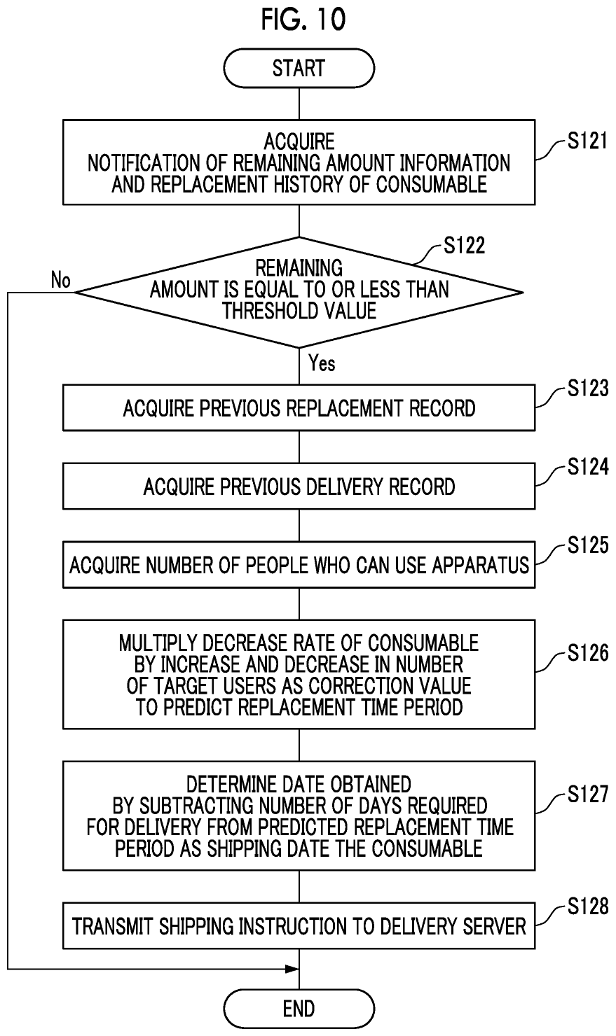

FIG. 10 is a flowchart showing a flow of the consumable management processing by the consumable management server 10. The consumable management processing is performed by the CPU 11 reading a computer program from the ROM 12 or the storage 14, loading the computer program into the RAM 13, and executing the computer program. FIG. 10 is a flowchart in a case of predicting the replacement time period of the consumable by using the fluctuation of the number of people who can use the apparatus 20.

Since steps S121 to S124 are identical to steps S101 to S104 in FIG. 7, detailed description thereof will be omitted. In a case where the previous delivery record of the consumable of the apparatus 20 is acquired from the delivery record database 40, the CPU 11 subsequently acquires the number of people who can use the apparatus 20 from the human operation situation management server 25 in step S125.

In a case where the number of people who can use the apparatus 20 is acquired from the human operation situation management server 25, the CPU 11 subsequently multiplies the decrease rate of the consumable of the apparatus 20 by the increase or decrease in the number of target users as a correction value to predict the replacement time period of the consumable in step S126. For example, the CPU 11 considers the past notification record of the apparatus 20 as the amount of usage in the number of personnel available at that time and uses an approximate curve to specify a decrease tendency of the consumable per number of personnel. Thereafter, in a case where the number of people who can use the apparatus 20 in the future can be acquired from the human operation situation management server 25, the CPU 11 calculates the replacement time period of the consumable in a case where the number of people is present. In a case where the number of personnel in the future cannot be acquired, the CPU 11 calculates the replacement time period of the consumable from the average number of personnel in the past record. In a case where the emphasis is on preventing the consumable from running out, the CPU 11 may calculate the replacement time period of the consumable on the assumption that the maximum number of personnel present who can use the apparatus 20 is maintained in the future.

Since steps S127 and S128 are identical to steps S106 and S107 in FIG. 7, detailed description thereof will be omitted.

In this way, the consumable management server 10 accurately predicts the replacement time period of the consumable by using the human operation situation as compared with a case of predicting the replacement time period of the consumable only by the transition of the remaining amount.

As described above, according to the exemplary embodiment of the present invention, in a case where the instruction of the shipment of the consumable of the apparatus 20 is made, the consumable management server 10 that makes the instruction of the shipment of the consumable is provided such that a new consumable arrives at the replacement time period of the consumable in consideration of the delivery period of the consumable according to the time period. In the consumable management server 10 according to the exemplary embodiment of the present invention, the occurrence of downtime due to missed arrival of a consumable and the decrease in efficiency of using a consumable due to the early arrival of the consumable may be prevented.

Note that various processors other than the CPU may execute the consumable management processing executed by the CPU reading the software (program) in each of the above exemplary embodiments. In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed. Further, the hardware-like structure of the various processors is, more specifically, an electric circuit in which circuit elements such as semiconductor elements are combined.

Further, in each of the above exemplary embodiments, although an aspect in which a program of the consumable management processing is stored (installed) in the ROM or the storage in advance has been described, the exemplary embodiment of the present invention is not limited to this. The program may be provided in a form recorded on a non-transitory recording medium such as a compact disk read only memory (CD-ROM), a digital versatile disk read only memory (DVD-ROM), and a universal serial bus (USB) memory. Further, the program may be downloaded from an external apparatus via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A consumable management apparatus comprising:
a processor configured to:
periodically acquire remaining amount information, which is related to a remaining amount to be used until replacement of a consumable, and a replacement history of the consumable, from an apparatus provided with the consumable;
acquire information about a delivery period, which is from shipment of the consumable to arrival of the consumable at an installation place of the apparatus, and a delivery time period corresponding to the replacement history;
predict a replacement time period of the consumable provided in the apparatus by using the remaining amount information; and
determine a time point that is before the delivery period, which is obtained in accordance with the delivery time period, from the predicted replacement time period, as a time point for shipping the consumable to the installation place.

2. The consumable management apparatus according to claim 1, wherein the processor is configured to:
acquire the information about the delivery period and the delivery time period from delivery data of the consumable.

3. The consumable management apparatus according to claim 2, wherein the processor is configured to:
in a case where the replacement history of the consumable is not present in the apparatus, acquire the information about the delivery period and the delivery time period corresponding to a replacement history of a consumable of another apparatus installed in an area identical to the installation place, from the delivery data of the consumable.

4. The consumable management apparatus according to claim 1, wherein the processor is configured to:
refer to the replacement history and consider a time point when the consumable is replaced as a time point when the consumable arrives.

5. The consumable management apparatus according to claim 4, wherein the processor is configured to:
in a case where the replacement history of the consumable is not present in the apparatus, refer to a replacement history of a consumable in another apparatus installed in an area identical to the installation place and consider a time point when the consumable is replaced in the other apparatus as the time point when the consumable arrives.

6. The consumable management apparatus according to claim 1, wherein the processor is configured to:
acquire information about the number of people capable of using the apparatus and predict the replacement time period of the consumable in the apparatus by using fluctuation of the number of people in addition to the remaining amount information.

7. The consumable management apparatus according to claim 2, wherein the processor is configured to:
acquire information about the number of people capable of using the apparatus and predict the replacement time period of the consumable in the apparatus by using fluctuation of the number of people in addition to the remaining amount information.

8. The consumable management apparatus according to claim 3, wherein the processor is configured to:
acquire information about the number of people capable of using the apparatus and predict the replacement time period of the consumable in the apparatus by using fluctuation of the number of people in addition to the remaining amount information.

9. The consumable management apparatus according to claim 4, wherein the processor is configured to:
acquire information about the number of people capable of using the apparatus and predict the replacement time period of the consumable in the apparatus by using fluctuation of the number of people in addition to the remaining amount information.

10. The consumable management apparatus according to claim 5, wherein the processor is configured to:
acquire information about the number of people capable of using the apparatus and predict the replacement time period of the consumable in the apparatus by using fluctuation of the number of people in addition to the remaining amount information.

11. The consumable management apparatus according to claim 6, wherein the processor is configured to:
acquire the information about the number of people at a timing when the remaining amount information is acquired.

12. The consumable management apparatus according to claim 7, wherein the processor is configured to:
acquire the information about the number of people at a timing when the remaining amount information is acquired.

13. The consumable management apparatus according to claim 8, wherein the processor is configured to:
acquire the information about the number of people at a timing when the remaining amount information is acquired.

14. The consumable management apparatus according to claim 9, wherein the processor is configured to:
acquire the information about the number of people at a timing when the remaining amount information is acquired.

15. The consumable management apparatus according to claim 10, wherein the processor is configured to:
acquire the information about the number of people at a timing when the remaining amount information is acquired.

16. The consumable management apparatus according to claim 1, wherein the processor is configured to:
acquire the information about the delivery period and the delivery time period in a case where a degree of use of the consumable exceeds a predetermined threshold value.

17. The consumable management apparatus according to claim 2, wherein the processor is configured to:
acquire the information about the delivery period and the delivery time period in a case where a degree of use of the consumable exceeds a predetermined threshold value.

18. The consumable management apparatus according to claim 1,
wherein the consumable is a consumable used in an image forming apparatus.

19. A non-transitory computer readable medium storing a computer program causing a computer to execute processing of:
periodically acquiring remaining amount information, which is related to a remaining amount to be used until replacement of a consumable, and a replacement history of the consumable, from an apparatus provided with the consumable;
acquiring information about a delivery period, which is from shipment of the consumable to arrival of the consumable at an installation place of the apparatus, and a delivery time period corresponding to the replacement history;
predicting a replacement time period of the consumable provided in the apparatus by using the remaining amount information; and
determining a time point that is before the delivery period, which is obtained in accordance with the delivery time period, from the predicted replacement time period, as a time point for shipping the consumable to the installation place.

20. A consumable management method comprising:
periodically acquiring remaining amount information, which is related to a remaining amount to be used until replacement of a consumable, and a replacement history of the consumable, from an apparatus provided with the consumable;
acquiring information about a delivery period, which is from shipment of the consumable to arrival of the consumable at an installation place of the apparatus, and a delivery time period corresponding to the replacement history;
predicting a replacement time period of the consumable provided in the apparatus by using the remaining amount information; and
determining a time point that is before the delivery period, which is obtained in accordance with the delivery time period, from the predicted replacement time period, as a time point for shipping the consumable to the installation place.
